(19) United States
(12) Patent Application Publication
(10) Pub. No.: US 2018/0232465 A1
(43) Pub. Date: Aug. 16, 2018

(54) Analysis Assistance System and Analysis Assistance Method

(71) Applicant: Hitachi, Ltd., Chiyoda-ku, Tokyo (JP)

(72) Inventors: Akira YONEKAWA, Tokyo (JP); Takashi YOKOHARI, Tokyo (JP)

(21) Appl. No.: 15/751,005

(22) PCT Filed: Aug. 25, 2015
(86) PCT No.: PCT/JP2015/073818

§ 371 Date: Feb. 7, 2018

(51) Int. Cl. G06F 17/50; G06F 17/30

(52) U.S. Cl. CPC G06F 17/50; G06F 2217/04; G06F 17/30259; G06F 17/30864

(57) ABSTRACT

Provided are an analysis assistance system and an analysis assistance method, whereby it is possible to easily divide an object to be analyzed into segments on the basis of past analysis cases, without requiring that the user has any particular degree of skill. This analysis assistance system has an analysis assistance device connected to a plurality of electronic terminal devices via a network. The analysis assistance device is provided with a case database which stores a plurality of past analysis cases, and a case search unit which searches the case database, wherein the case search unit: searches the case database and thereby extracts past analysis cases similar to an object to be analyzed that is received from one of the electronic terminal devices; generates, from the extracted past analysis cases, a histogram of combinations of segment size and analysis time and/or a histogram of combinations of analysis model shape similarity and analysis time; and displays these histograms on a display unit of the electronic terminal device.

### TECHNICAL FIELD

The present invention relates to an analysis assistance system using a CAD, and more particularly to, an analysis assistance system and an analysis assistance method which are capable of reducing efforts of a user in an analysis process for an analysis target or improving operability.

### BACKGROUND ART

A usual analysis process is implemented by generating a shape model using a CAD, converting and dividing the shape model into meshes, that is, analysis models (mesh models) configured with a plurality of partial shapes, and executing an analysis program of obtaining an analytic solution. In a case in which the user is an unskilled person or in the case of a shape on which analysis is performed for the first time even if the user is a skilled person, it is difficult to know how to set a mesh. In this regard, a method of searching and presenting a similar case has been proposed in, for example, PTL 1.

In PTL 1, a configuration in which previous analysis cases with high relevance are displayed in series on the basis of “relevance” stored in an analysis case database in addition to a load condition such as a uniformly distributed load or a concentrated load and a constraint condition such as an edge support and a fixed edge which are input as keywords by the user at the time of search is disclosed. The “relevance” stored in the analysis case database is a value arbitrarily set by the user when a case is registered in the analysis case database.

### CITATION LIST

### Patent Literature

PTL 1: JP 2011-227650 A

### SUMMARY OF INVENTION

### Technical Problem

However, in the technique disclosed in PTL 1, the “relevance” depends on a subjective view of the user, that is, the user, and thus in a shared analysis case database, there is a variation in the “relevance” assigned to each analysis case, and reliability of a search result is likely to be lowered.

In this regard, the present invention provides an analysis assistance system and an analysis assistance method which are capable of easily dividing an analysis target into partial shapes on the basis of a previous analysis case without depending on a degree of skill of the user.

### Solution to Problem

In order to solve the problem, an analysis assistance system according to the present invention includes an analysis assistance device connected to at least one or more electronic terminal devices via a network, wherein the analysis assistance device comprises a case database that accumulates a plurality of previous analysis cases, and a case search unit that searches the case database, the case search unit searches the case database, extracts a previous analysis case similar to an analysis target received from the electronic terminal device via the network, generates a histogram of a combination of an analysis time and a partial shape size and/or a combination of an analysis time and shape similarity at the time of analysis modeling in the extracted previous analysis case, and causes the histogram to be displayed on a display unit of the electronic terminal device.

In addition, an analysis assistance method according to the present invention includes: an analysis target input process of receiving, by an analysis assistance device, an analysis target from at least one or more electronic terminal devices via a network; a case search process of searching a case database that accumulates a plurality of previous analysis cases for a previous analysis case similar to the received analysis target and extracting the previous analysis case; a process of generating, by the analysis assistance device, a histogram of a combination of an analysis time and a partial shape size and/or a combination of an analysis time and shape similarity at the time of analysis modeling in the extracted previous analysis case; and a process of causing the generated histogram of the combination of the analysis time and the partial shape size and/or the combination of the analysis time and the shape similarity at the time of analysis modeling to be displayed on a display unit of the electronic terminal device.

### Advantageous Effects of Invention

According to the present invention, it is possible to provide an analysis assistance system and an analysis assistance method which are capable of easily dividing an analysis target into partial shapes on the basis of a previous analysis case without depending on a degree of skill of the user.

Problems, configurations, and effects which are not described above will be apparent from description of the following embodiments.

### BRIEF DESCRIPTION OF DRAWINGS

FIG. 1 is a schematic overall configuration diagram of an analysis assistance system according to one embodiment of the present invention.

FIG. 2 is a schematic overall configuration diagram of an analysis assistance device illustrated in FIG. 1.

FIG. 3 is a schematic overall configuration diagram of an electronic terminal device illustrated in FIG. 1.

FIG. 4 is a diagram showing examples of a shape of an analysis target and an analysis model divided into partial shapes.

FIG. 5 is a diagram illustrating a screen display example of an electronic terminal device illustrated in FIG. 1.

FIG. 6 is a diagram illustrating a screen display example of an electronic terminal device illustrated in FIG. 1, that is, a display example of a search result.

FIG. 7 is a flowchart illustrating a processing process performed in an analysis assistance system of a first embodiment according to one embodiment of the present invention.

FIG. 8 is a flowchart illustrating a processing process of a case search unit and an analyzing unit constituting the analysis assistance device illustrated in FIG. 2.

FIG. 9 is a diagram illustrating a screen display example of an electronic terminal device of the first embodiment, that is, a state in which a search condition is input.

FIG. 10 is a diagram illustrating a display screen example of the electronic terminal device of the first embodiment, that is, a display example of a search result.

FIG. 11 is a diagram illustrating a display screen example of the electronic terminal device of the first embodiment, that is, a state in which a desired histogram in a search result is selected.

FIG. 12 is a diagram illustrating a display screen example of the electronic terminal device of the first embodiment, that is, a state in which a partial shape size obtained on the basis of a selected histogram is displayed.

FIG. 13 is a flowchart illustrating a processing process performed in an analysis assistance system of a second embodiment according to another embodiment of the present invention.

FIG. 14 is a flowchart illustrating a processing process of a case search unit and an analyzing unit constituting an analysis assistance device illustrated in FIG. 2.

FIG. 15 is a diagram illustrating a display screen example of an electronic terminal device of the second embodiment, that is, a display example of a search result.

FIG. 16 is a diagram illustrating a display screen example of the electronic terminal device of the second embodiment, that is, a state in which a desired histogram in a search result is selected.

FIG. 17 is a diagram illustrating a display screen example of the electronic terminal device of the second embodiment, that is, a state in which a partial shape size obtained on the basis of a selected histogram is displayed.

### DESCRIPTION OF EMBODIMENTS

In this specification, an “analysis target” refers to an object having a three-dimensional shape such as a columnar object, a conical object, a cylindrical object, or a trigonal pyramid object, and the “analysis target” is an object to be divided into a plurality of partial shapes, an analysis model is configured with a plurality of “partial shapes” after it is divided into “partial shapes,” and the analysis model is also referred to as a “mesh model.” Hereinafter, in this specification, a cube or a columnar object having a simplified shape is described as an example of the analysis target, but practically, the “analysis target” often has a complicated shape, for example, as in a complex piping network in a plant or parts constituting an internal combustion engine.

An “analysis region” is a target region to be analyzed and may be configured with a plurality of “analysis targets” or may be configured with the entirety of one “analysis target” or one or more arbitrary partial regions of the “analysis target.” As an analysis process, for example, thermal variance analysis or stress analysis is executed.

In this specification, a “partial shape” refers to one or more meshes when it is converted into a mesh model (analysis model).

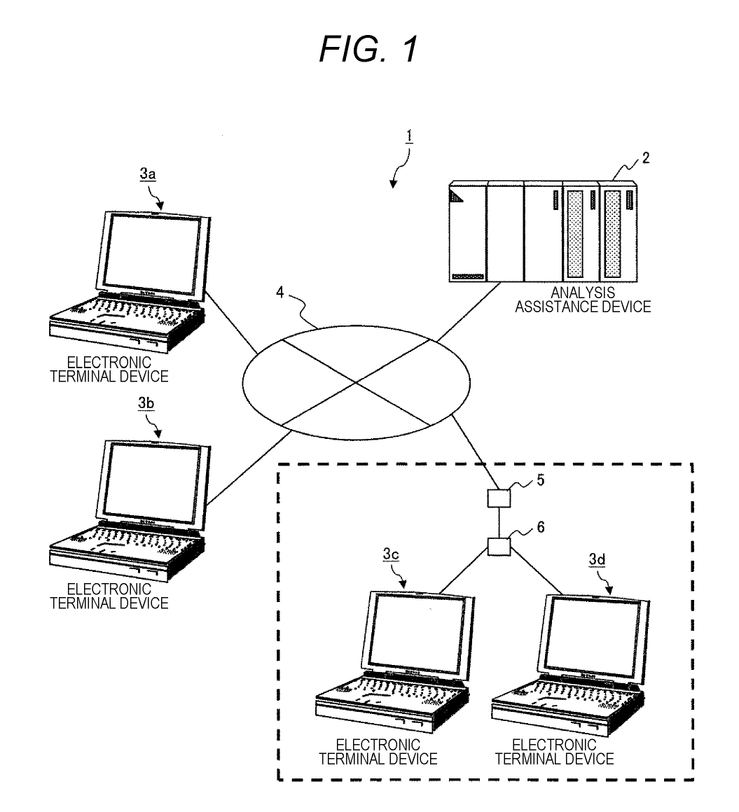

FIG. 1 illustrates a schematic overall configuration diagram of an analysis assistance system according to one embodiment of the present invention. An analysis assistance system 1 includes an analysis assistance device 2 implemented by a server or the like, a plurality of electronic terminal devices 3a to 3d implemented by a personal computer or the like, and a network 4 enabling them to communicate with one other. As illustrated in FIG. 1, the electronic terminal device 3c is connected to the network 4 via a switch 6 and a router 5 through a communication I/F to be described later. Similarly, the electronic terminal device 3d is connected to the network 4 via the switch 6 and the router 5 through the communication I/F.

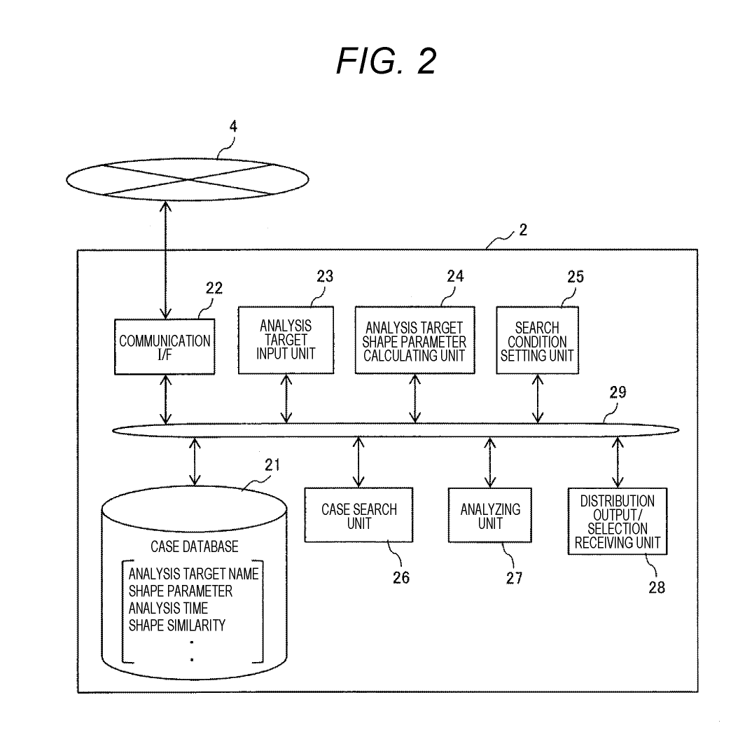

FIG. 2 illustrates a schematic overall configuration diagram of the analysis assistance device illustrated in FIG. 1. As illustrated in FIG. 2, the analysis assistance device 2 includes a case database 21 that accumulates a plurality of previous analysis cases, a communication I/F 22 that enables communication with each electronic terminal device via the network 4, an analysis target input unit 23, an analysis target shape parameter calculating unit 24 that calculates a shape parameter of an input analysis target, a search condition setting unit 25, a case search unit 26, an analyzing unit 27, and a distribution output/selection receiving unit 28 which are connected with one another via an internal bus 29.

For example, each of the analysis target input unit 23, the analysis target shape parameter calculating unit 24, the search condition setting unit 25, the case search unit 26, the analyzing unit 27, and the distribution output/selection receiving unit 28 is implemented by a processor such as a CPU and a storage device such as a ROM that stores a program and a RAM that temporarily stores data of a process of executing the program read from the ROM through the processor or the like.

The case database 21 stores the previous analysis case in association with, for example, an “analysis target name,” a “shape parameter,” an “analysis time,” “shape similarity,” “mesh data,” “the number of partial shapes constituting an analysis model,” “drawing,” a “partial shape type included in an analysis target,” “the number of analysis targets included in an analysis region,” “analysis process content,” an “analyzer,” or the like for each previous analysis case.

Here, examples of the “analysis target name” include a shaft (rotating shaft) constituting an electric motor or a generator, a water supply pipe or a drain pipe in a plant, and a piston, a cylinder, or the like in an internal combustion engine. Further, examples of the “shape parameter” include a volume/area, a surface area, and a fractal dimension (the number of divisions) of an analysis target, apart of an analysis target, a size of an analysis region, a partial shape size, and an aspect ratio. Examples of the “shape similarity” include similarity between the analysis target and the analysis model after the analysis target is divided into a plurality of partial shapes, that is, similarity between the analysis target and the analysis model at the time of analysis modeling, which will be described later in detail. Examples of the “analyzer” include a name of a person in charge and a name of a department to which the person in charge belongs.

For example, the analysis target input unit 23 acquires the analysis target included in the CAD data input from the electronic terminal devices 3a to 3d via the network 4, the communication I/F 22, and the internal bus 29. The analysis target included in the acquired CAD data includes at least a name of the analysis target, a shape of the analysis target, a size of the analysis target, and an analysis region. The analysis target shape parameter calculating unit 24 acquires the analysis target from the analysis target input unit 23 via the internal bus 29 and calculates the shape parameter of the analysis target. The search condition setting unit 25 acquires a search condition input by the user using the electronic terminal device (3a to 3d) via the network 4, the communication I/F 22, and the internal bus 29. For a search condition input screen displayed on the display screen of the electronic terminal device (3a to 3d) to be described later, a display program of the search condition input screen may be transmitted from the search condition setting unit 25 to each electronic terminal device (3a to 3d) via the network 4 in advance, for example, through process migration or the like, or the display program of the search condition input screen may be preinstalled in each electronic terminal device (3a to 3d).

The case search unit 26 refers to the case database 21 and extracts previous cases corresponding to the shape parameter of the analysis target calculated by the analysis target parameter calculating unit 24 and the search condition set by the search condition setting unit 25 from the case database 21. For example, the analyzing unit 27 counts a plurality of previous cases extracted by the case search unit 26 for each partial shape size when the analysis target is divided into a plurality of partial shapes and converted into an analysis model, and obtains a relation between the partial shape size and the number of cases. The preset invention is not limited to this example, and for example, the case search unit 26 may be configured to count the number of cases for each partial shape size each time while extracting the previous cases for each partial shape size with reference to the case database 21. In this case, it may be incorporated into one program so that reference to the case database 21, the extraction of the previous cases, and the counting of the number of cases for each partial shape size are executed.

The distribution output/selection receiving unit 28 outputs the relation between the partial shape size and the number of cases obtained from the analyzing unit 27 to a corresponding electronic terminal device (3a to 3d), that is, the electronic terminal device which has transmitted the analysis target included in the CAD data to the analysis assistance device 2 via the communication I/F 22 and the network 4 as a histogram (distribution). Selection of a desired histogram from a plurality of histograms displayed by the electronic terminal device and acquisition by the distribution output/selection receiving unit 28 of the selected histogram will be described later.

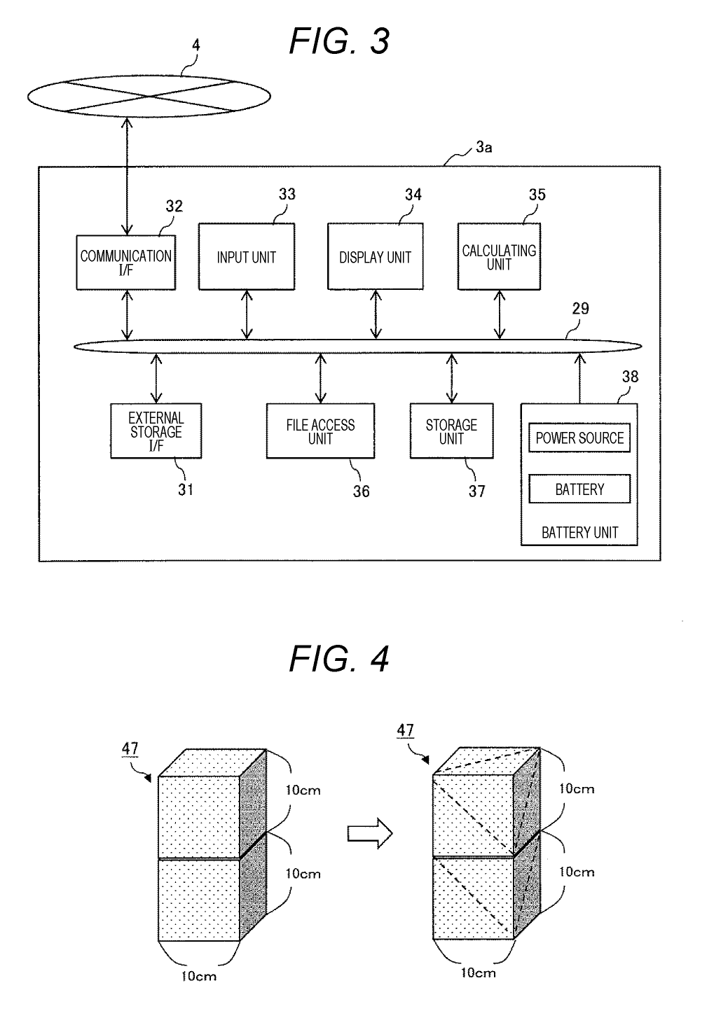

FIG. 3 illustrates a schematic overall configuration diagram of the electronic terminal device illustrated in FIG. 1. In FIG. 3, only the electronic terminal device 3a among the electronic terminal devices 3a to 3d is illustrated, but the other electronic terminal devices 3b to 3d are also similar. As illustrated in FIG. 3, the electronic terminal device 3a includes an external storage I/F 31, a communication I/F 32, an input unit 33 such as a keyboard or a mouse, a display unit 34 such as an LCD or an organic EL display, a calculating unit 35, a file access unit 36, a storage unit 37, and a battery unit 38 which are connected to one another via an internal bus 39.

For example, each of the calculating unit 35 and the file access unit 36 is implemented by a processor such as a CPU and a storage device such as a ROM that stores a program and a RAM that temporarily stores data of a process of executing the program read from the ROM through the processor or the like.

The external storage I/F 31 enables an external storage device such as a portable HDD or USB (not illustrated) to be inserted into and extracted from the electronic terminal device 3a and enables data to be written in or read from an external storage device. The battery unit 38 includes a power source or a battery such as a secondary battery, and at least drawing data such as CAD data is stored in the storage unit 37. The calculating unit 35 performing a process of transmitting the analysis target included in the CAD data serving as a target of the analysis process to the analysis assistance device 2 via the communication I/F 32 and the network 4. The calculating unit 35 has a function of reading and executing various application programs stored in the storage unit 37 in addition to the above-described functions. The file access unit 36 acquires a command given from the calculating unit 35 via the internal bus 39, accesses the storage unit 37 in accordance with the command, extracts the CAD data including the analysis target, and transfers the CAD data to the calculating unit 35 via the internal bus 39.

Here, a relation between the analysis target and the analysis model will be described. FIG. 4 is a diagram illustrating an example of an analysis model after division into shape and partial shape of analysis target. As illustrated in a left diagram of FIG. 4, an analysis target 47 which is a cube has a shape in which two regular hexahedrons each having a side of 10 cm are vertically stacked. A right diagram of FIG. 4 illustrates a state in which the analysis target illustrated in the left diagram is divided into tetras which are tetrahedral elements (partial shapes) having three sides of 10 cm and remaining three sides of 10√2 cm and converted into analysis models as indicated by dotted lines.

Next, as an example, the analysis target 47 which is the cube illustrated in the left diagram of FIG. 4 may be transmitted to the analysis assistance device 2 via the communication I/F 32 and the network 4 through the calculating unit 35 constituting the electronic terminal device 3a (FIG. 3). The analysis target 47 is acquired into the analysis target input unit 23 constituting the analysis assistance device 2 (FIG. 2) via the communication I/F 22 and the internal bus 29. The acquired analysis target 47 is transferred to the analysis target shape parameter calculating unit 24 via the internal bus 29. The analysis target shape parameter calculating unit 24 calculates a volume, a surface area, a fractal dimension, and the like of the analysis target 47 as the shape parameters since the acquired analysis target 47 has a shape in which the two regular hexahedrons each having a side of 10 cm are vertically stacked.

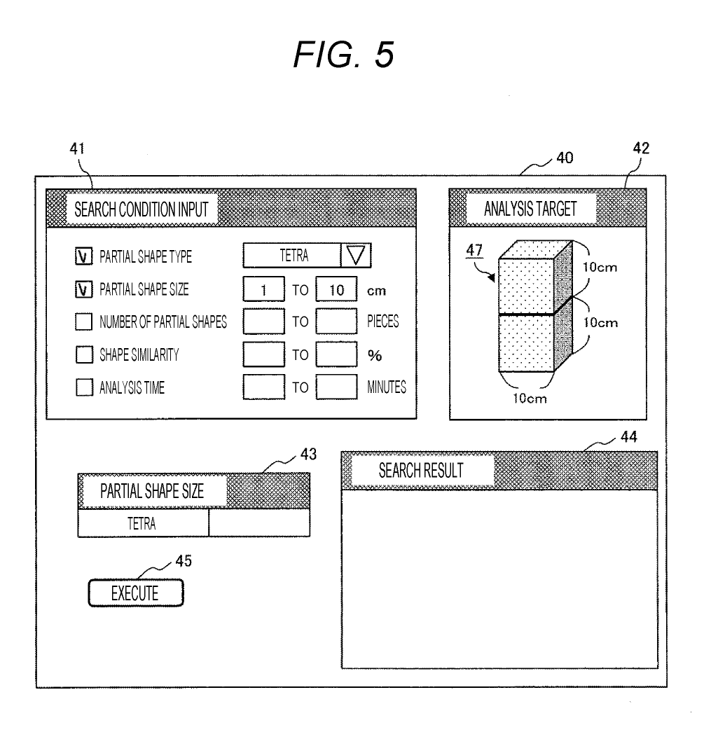

Display information displayed on the display screen of the display unit 34 constituting the electronic terminal device 3a at this time will be described. FIG. 5 illustrates a screen display example of the electronic terminal device 3a. As illustrated in FIG. 5, a display screen 40 of the electronic terminal device 3a includes a search condition input region (first display region) 41, an analysis target display region (second display region) 42, a partial shape display region (third display region) 43, a search result display region (fourth display region) 44, and an execution button 45. The analysis target 47 which is a cube in which the two regular hexahedrons each having a side of 10 cm are vertically stacked is displayed in the analysis target display region (second display region) 42. The search condition input region (first display region) 41 is a region that enables the user to designate and input a search condition for searching the previous analysis case accumulated in the case database 21 constituting the analysis assistance device 2. In the example illustrated in FIG. 5, a “partial shape type,” a “partial shape size,” “the number of partial shapes” (the number of partial shapes forming the analysis model), “shape similarity, ” and an “analysis time” are prepared, and a state illustrated in FIG. 5 is a state in which the user designates and inputs “tetra” as the “partial shape type” and designates and inputs “1 cm to 10 cm” as the “partial shape size.” A pull-down button is provided in a “partial shape type” field, and the user can select and designate a desired partial shape through the pull-down button. Further, a “blank cell” may be provided as a selection item selected by the pull-down button so that the partial shape name can be directly input by the user. The partial shape display region (third display region) 43 is a region in which the size (partial shape size) of “tetra” designated by the user is displayed as the partial shape, and a recommended size is displayed on the basis of a search result of the case database 21 constituting the analysis assistance device 2, and this region will be described later in detail. The search result display region (fourth display region) 44 is a region in which a histogram based on the search result of the case database 21 is displayed, and a state illustrated in FIG. 5 is a non-displayed state. In the state illustrated in FIG. 5, when the user moves a cursor to the position of the “execution button” 45 and clicks a mouse serving as the input unit 33, a designated search condition indicated in the search condition input region (first display region) 41 is transmitted to the analysis assistance device 2 via the communication I/F 32 and the network 4 through the calculating unit 35.

The search condition setting unit 25 constituting the analysis assistance device 2 acquires the search condition designated by the user in which the “partial shape type” is “tetra,” and the “partial shape size” is “1 cm to 10 cm” via the communication I/F 22 and the internal bus 29. The search condition setting unit 25 transfers the acquired search condition to the case search unit 26 via the internal bus 29. The case search unit 26 performs a search with reference to the case database 21 using the transferred search condition and the volume, the surface area, and the fractal dimension of the analysis target 47 which are the shape parameters of the analysis target 47 previously calculated by the analysis target shape parameter calculating unit 24. The case search unit 26 extracts a plurality of previous analysis cases satisfying the search condition on the basis of the shape parameter of the search target 47 and transmits the extracted previous analysis cases to the analyzing unit 27 via the internal bus 29. The analyzing unit 27 counts the number of analysis cases for each search condition, here, for each partial shape size for a plurality of previous analysis cases satisfying the search condition transmitted from the case search unit 26, and generates a histogram which is a relation between the partial shape size and the number of cases. In this specification, usually, one obtained by performing broken line approximation on a histogram indicated by a bar graph is referred to as a “histogram.”

The analyzing unit 27 transmits the generated histogram to the distribution output/selection receiving unit 28 via the internal bus 29. The distribution output/selection receiving unit 28 transmits a histogram in which a horizontal axis indicates the partial shape size, and a vertical axis indicates the number of cases to the electronic terminal device 3a via the communication I/F 22 and the network 4 as a search result.

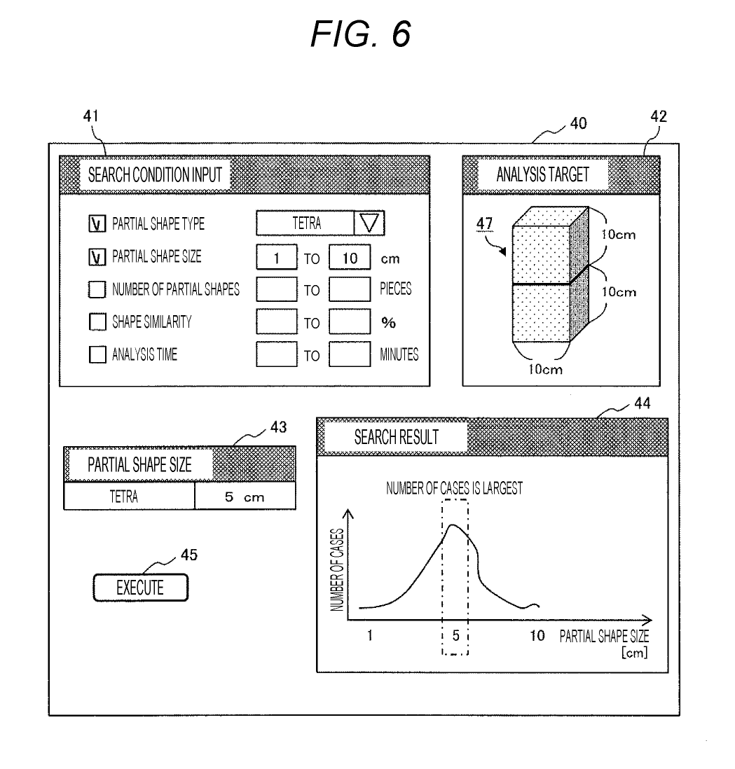

FIG. 6 illustrates a display screen example of the electronic terminal device 3a when the histogram serving as the search result is received from the analysis assistance device 2 via the network 4. As illustrated in FIG. 6, a histogram which is a distribution of the number of cases in which the partial shape size is 1 cm to 10 cm is displayed on the search result display region (fourth display region) 44. In the state illustrated in FIG. 6, a rectangular selection designation bar (indicated by an alternate long and short dash line in FIG. 6) which enables the user to perform selection and designation is displayed on the search result display region (fourth display region) 44, in addition to the histogram. The user can designate a desired region in the histogram by dragging the selection designation bar with the mouse or the like which is the input unit 33. In the example illustrated in FIG. 6, the selection designation bar is positioned at a position at which the partial shape size having the largest number of cases is 5 cm, and the partial shape size of 5 cm in which the partial shape is “tetra” is displayed on the partial shape display region (third display region) 43.

In the analysis assistance system 1 according to the present embodiment, as described above, the histogram of the number of previous analysis cases satisfying the search condition designated by the user is displayed on the screen of the electronic terminal device (the search result display region (fourth display region) 44), and thus even when the user is an unskilled person, it is possible to easily divide the analysis target into a plurality of partial shapes on the basis of the previous analysis cases accumulated in the case database 21.

Detailed operations of the analysis assistance system 1 and the analysis assistance device 2 and the electronic terminal device (3a to 3d) constituting the analysis assistance system 1 will be described with reference to the drawings.

### First Embodiment

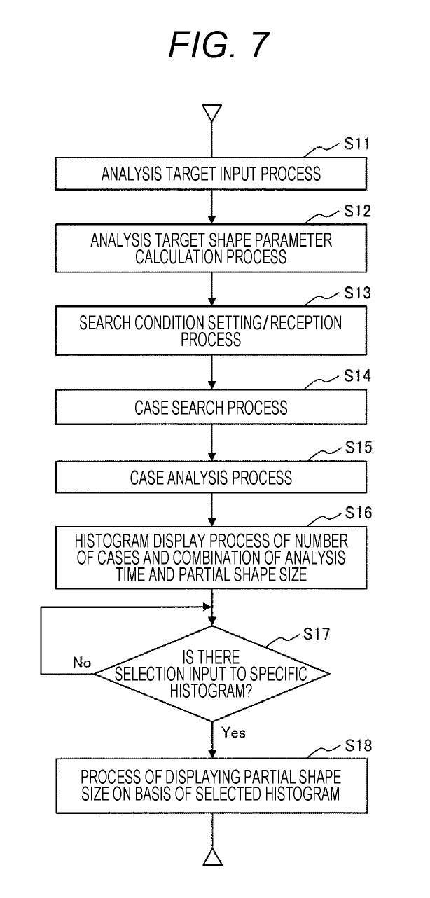

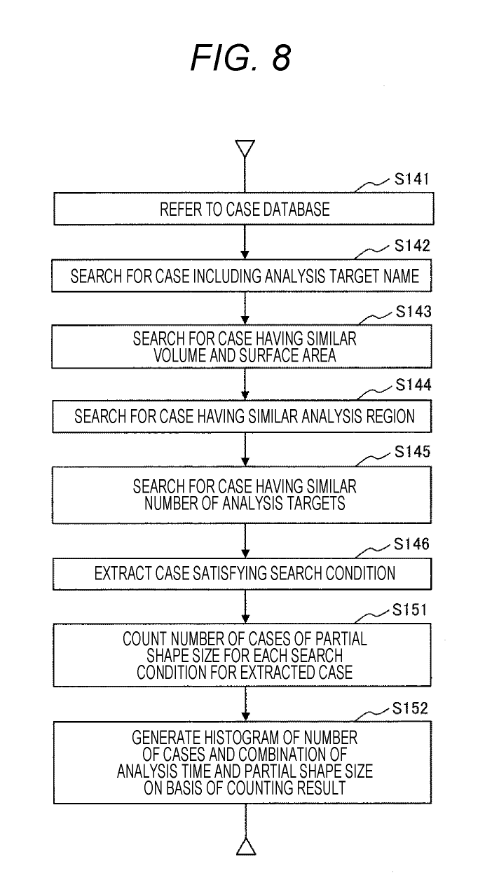

FIG. 7 is a flowchart illustrating a processing process performed in an analysis assistance system of a first embodiment according to one embodiment of the present invention, and FIG. 8 is a flowchart illustrating a processing process of the case search unit and the analyzing unit constituting the analysis assistance device. An overall configuration of the analysis assistance system 1 and overall configurations of the analysis assistance device 2 and the electronic terminal device (3a to 3d) constituting the analysis assistance system 1 are similar to those described above with reference to FIGS. 1 to 3. In the present embodiment, a process between the analysis assistance device 2 and the electronic terminal device 3a will be described below in connection with an example in which the “analysis target name” is a “shaft (rotating shaft) of an electric motor,” and the “analysis target” is a “columnar object.”

In an analysis target input process (step S11) illustrated in FIG. 7, the calculating unit 35 constituting the electronic terminal device 3a (FIG. 3) accesses the storage unit 37 via the file access unit 36, and acquires CAD data including an analysis target 48 included in the CAD data serving as the target of the analysis process, that is, the analysis target 48 which is the columnar object which is the shaft (rotating shaft) of the electric motor. Thereafter, the calculating unit 35 transmits the CAD data including the analysis target 48 which is the columnar object to the analysis assistance device 2 via the communication I/F 32 and the network 4. The analysis target input unit 23 constituting the analysis assistance device 2 (FIG. 2) acquires the CAD data including the analysis target 48 which is the columnar object via the communication I/F 22 and the internal bus 29. Here, the acquired CAD data including the analysis target 48 which is the columnar object includes at least the “shaft (rotating shaft) of the electric motor” which is the “analysis target name, ” the columnar object which is the shape of the analysis target, the size of the analysis target, and the analysis region.

In an analysis target shape parameter calculation process (step S12), the analysis shape parameter calculating unit 24 acquires the CAD data including the analysis target 48 which is the columnar object from the analysis target input unit 23 via the internal bus 29. The analysis shape parameter calculating unit 24 calculates the volume, the surface area, and the fractal dimension of the analysis target 48 as the shape parameters on the basis of the size (dimension) of the analysis target 48 which is the columnar object, transmits the volume, the surface area, and the fractal dimension of the analysis target 48 to the case search unit 26 via the internal bus 29, and causes the process to proceed to next step S13.

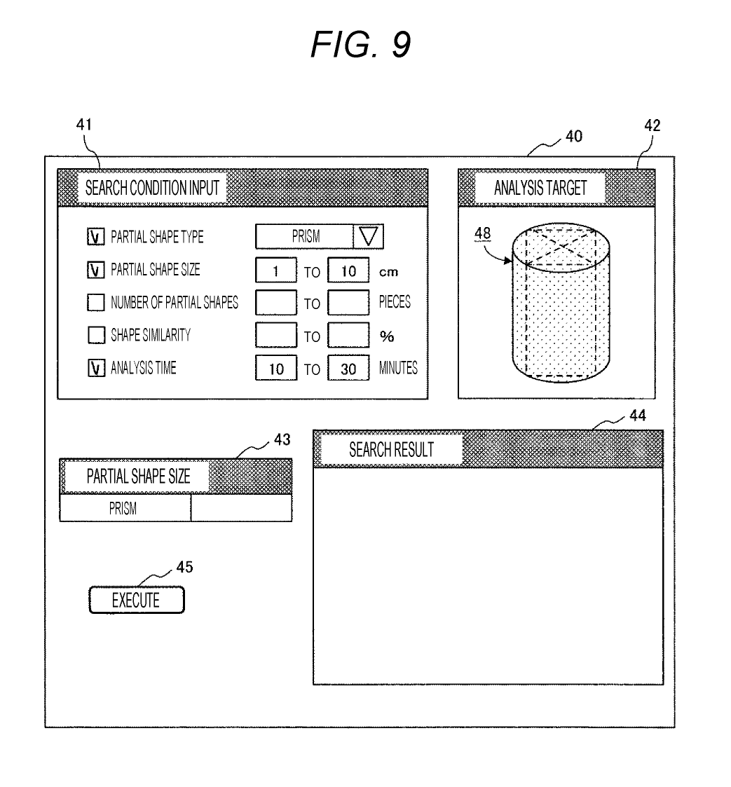

In a search condition setting/reception process (step S13), firstly, the search condition designated by the user and input to the search condition input region (first display region) 41 in the display screen 40 of the display unit 33 of the electronic terminal device 3a illustrated in FIG. 9 is received. The example illustrated in FIG. 9 illustrates a state in which a “prism” is designated and input as the “partial shape type,” “1 cm to 10 cm” is designated and input as the “partial shape size,” and “10 minutes to 30 minutes” is designated and input as the “analysis time” as the search condition. Further, a state in which the columnar object serving as the analysis target 48 is displayed in the analysis target display region (second display region) 42 as illustrated in FIG. 9 is illustrated. Here, in order to facilitate understanding of the description, a state in which the analysis target 48 is divided into triangular prisms which are pentahedral elements (partial shapes) indicated by a dotted line in the analysis target 48 and converted into the analysis model is illustrated. The analysis model is configured with four prisms. The “shape similarity” is similarity between the analysis target 48 which is the columnar object and the analysis model after the analysis target 48 is divided into a plurality of partial shapes (four prisms) and is indicated by, for example, the following Formula (1) as an exponent a of a difference between the outer surface shape of the analysis target 48 and the outer surface shape of the analysis model.

[Math. 1]

α=Σ(x_{S}−x_{M})²+Σ(y_{S}−y_{M})²+Σ(Z_{S}−Z_{M})² (1)

Here, coordinates (X_{S}, Y_{S}, Z_{S}) are surface coordinates of the analysis target 48, and coordinates (X_{M}, Y_{M}, Z_{M}) are surface coordinates of the analysis model (configured with four prisms). As the size of the partial shape decreases, the exponent α which is the shape similarity decreases. In other words, as the size of the partial shape decreases, the similarity between the analysis target 48 and the analysis model increases. Conversely, as the size of the partial shape increases, the exponent α increases, and the similarity between the analysis target 48 and the analysis model decreases. In other words, the “partial shape size” and the “shape similarity” are in an inverse proportional relation.

The shape similarity is not limited to the exponent a in Formula (1) and can be used as an index of the shape similarity as long as it is an operation expression capable of evaluating a deviation amount between the analysis target 48 and the analysis model. However, in this case, the shape similarity to be used needs to be unified.

Returning to FIG. 9, when the user moves the cursor to the execution button 45 by the mouse which is the input unit 33 and clicks the execution button in the state in which the search condition designated and input in the search condition input region (first display region) 41 is illustrated in FIG. 9, the calculating unit 35 transmits the search condition designated and input via the communication I/F 32 and the network 4 to the analysis assistance device 2. The search condition setting unit 25 constituting the analysis assistance device 2 acquires the search condition designated and input by the user via the communication I/F 22 and the internal bus 29. The search condition setting unit 25 transfers the search condition in which the “partial shape type” is the “prism,” the “partial shape size” is “1 cm to 10 cm,” and the “analysis time” is “10 minutes to 30 minutes” via the internal bus 29 to the case search unit 26 and causes the process to proceed to step S14 illustrated in FIG. 7.

The case search unit 26 performs the case search process of step S14, and the analyzing unit 27 performs the case analysis process of step S15. Here, step S14 and step S15 will be described in detail. FIG. 8 is a flowchart illustrating a processing process of the case search unit 26 and the analysis 27 and illustrates a detailed process of step S14 and step S15 illustrated in FIG. 7.

As illustrated in FIG. 8, the case search unit 26 refers to the case database 21 in which a plurality of previous analysis cases are accumulated (stored) via the internal bus 29 (step S141). As described above, the case database 21 stores the previous analysis case in association with, for example, an “analysis target name,” a “shape parameter,” an “analysis time,” “shape similarity,” “mesh data,” “the number of partial shapes constituting an analysis model,” “drawing,” a “partial shape type included in an analysis target,” “the number of search targets included in an analysis region,” “analysis process content,” an “analyzer,” and the like for each previous analysis case.

In step S142, the case search unit 26 searches for a case in which the “analysis target name” is the “shaft (rotating shaft) of the electric motor” among the previous analysis cases stored in the case database 21 and extracts a corresponding previous analysis case. Then, the case search unit 26 searches for the previous analysis case having the volume and the surface area similar to those of the analysis target 48 which is the columnar object among the previous analysis cases extracted in step S142 and extracts a corresponding previous analysis case. Here, the volume and the surface area of the analysis target 48 which is the columnar object has been calculated by the analysis shape parameter calculating unit 24 in step S12 of FIG. 7 and already been transmitted to the case search unit 26.

In step S144, the case search unit 26 searches for the previous analysis case having a similar analysis region among the previous analysis cases extracted in step S143 and extracts a corresponding previous search case. Here, the analysis region is a target region to be analyzed as described above and may be configured with a plurality of analysis targets 48 or may be configured with the entirety of one analysis target 48 or one or more arbitrary partial regions of the analysis target 48.

In step S145, the case search unit 26 searches for the previous analysis case having a similar number of analysis targets 48 included in the analysis region among the previous analysis cases extracted in step S144, extracts a corresponding previous analysis case, and causes the process to proceed to step S146.

In step S146, the case search unit 26 searches for the previous analysis case satisfying the search condition in which the “partial shape type” is “prism,” the “partial shape size” is “1 cm to 10 cm,” and the “analysis time” is “10 minutes to 30 minutes” from the previous analysis cases extracted in step S145 and extracts the corresponding previous analysis case. The previous analysis case satisfying the extracted search condition is transmitted from the case search unit 26 to the analyzing unit 27 via the internal bus 29.

In step S151, the analyzing unit 27 counts the number of cases of the partial shape size for each search condition for the previous analysis case satisfying the search condition extracted by the case search unit 26. At this time, the number of cases of the analysis time is also counted together.

In step S152, the analyzing unit 27 generates a histogram indicating a relation between the number of cases and a combination of the analysis time and the partial shape size on the basis of the counting result of the number of cases obtained in step S151.

Further, step S145 of FIG. 8 is skipped if the analysis region transmitted from the electronic terminal device 3a to the analysis assistance device 2 is the entirety of one analysis target 48 or one or more arbitrary partial regions of the analysis target 48. In other words, step S146 is executed after step S144 is executed. In the present embodiment, the example in which the case search unit 26 executes steps S143 to S145 serially is described, but the present invention is not limited to this. For example, the case search unit 26 may be configured to execute step S143, step S144, and step S145 in parallel. However, in this case, it is preferable to take AND (logical product) of the previous analysis cases obtained by executing step S143 to step S145 in parallel and then proceed to step S146.

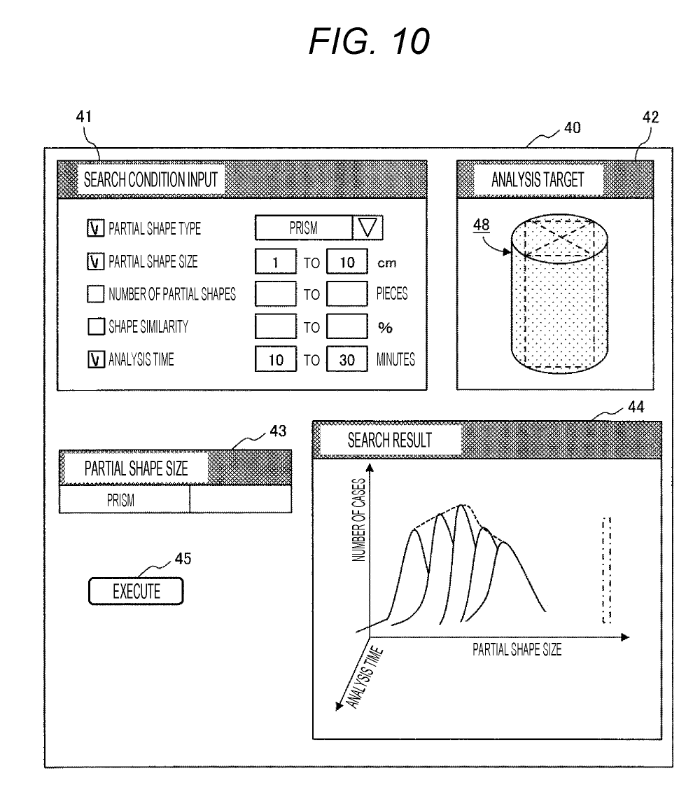

Here, the histogram display process (step S16) of the number of cases and the combination of the analysis time and the partial shape size will be described with reference to FIG. 7. In step S16, the distribution output/selection receiving unit 28 receives the execution result of step S15, that is, the histogram indicating the relation between the number of cases and the combination of the analysis time and the partial shape size obtained in step S152 illustrated in FIG. 8 from the analyzing unit 27 via the internal bus 29. The distribution output/selection receiving unit 28 outputs the histogram indicating the relation between the number of cases and the combination of the analysis time and the partial shape size to the electronic terminal device 3a via the communication I/F 22 and the network 4. The electronic terminal device 3a causes the received histogram indicating the relation between the number of cases and the combination of the analysis time and the partial shape size to be displayed on the display unit 34 via the communication I/F 32. FIG. 10 illustrates a display screen example of the display unit 34 of the electronic terminal device 3a at this time. As illustrated in FIG. 10, a plurality of histograms in which an X axis indicates the partial shape size, a Y axis indicates the analysis time, and a Z axis indicates the number of cases are displayed on the search result display region (fourth display region) 44 in the display screen 40. A dotted line connecting apexes of the displayed histograms indicates a partial shape size in which the number of cases is the largest in each histogram, and the analysis time decreases as the position of the histogram gets closer to the front. In other words, the analysis speed increases as the position of the histogram gets closer to the front. As described above, since the respective histograms are displayed, in a case in which the user is an unskilled person or in the case of a shape on which analysis is performed for the first time even if the user is a skilled person, it is possible to understand the relation between the number of previous analysis cases and the combination of the analysis time and the partial shape size in one glance, and it is possible to reduce the efforts of the user at the time of analysis modeling.

In the partial shape size corresponding to the histogram located at the forefront (the largest partial shape size), the analysis time is, for example, about 10 minutes, and in the partial shape size corresponding to the second histogram from the front, the analysis time is about 10 minutes to 12 minutes. In the state illustrated in FIG. 10, in addition to the histogram, a rectangular selection designation bar (indicated by an alternate long and short dash line in FIG. 10) that enables the user to perform selection and designation is displayed on the search result display region (fourth display region) 44.

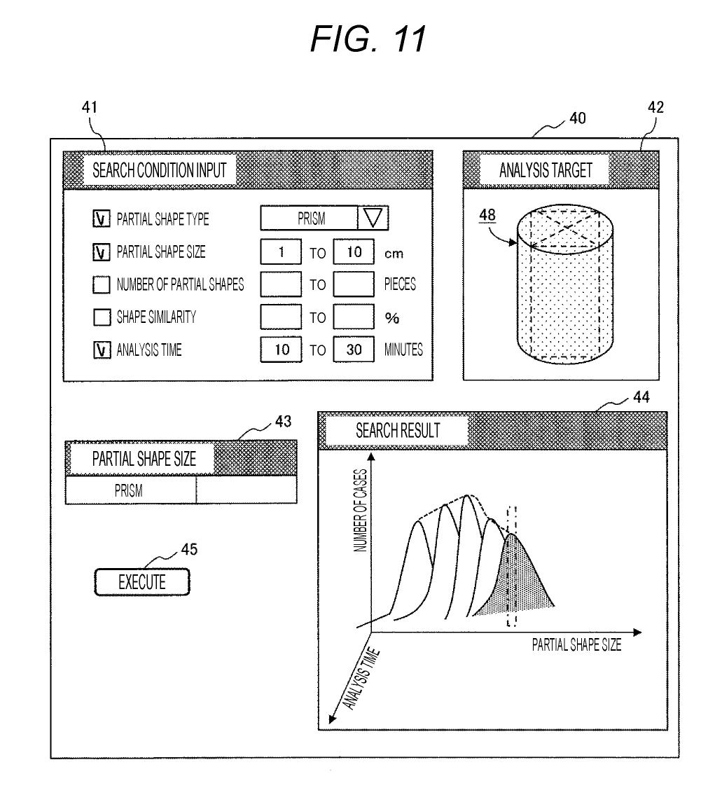

Then, in step S17 illustrated in FIG. 7, the calculating unit 35 constituting the electronic terminal device 3a determines the presence or absence of a selection input to a specific histogram by the user for the histogram indicating the relation between the number of cases and the combination of the analysis time and the partial shape size displayed in the search result display region (fourth display region) in the display screen. The determination on the presence or absence of the selection input is repeatedly executed until there is a selection input to the specific histogram by the user. As illustrated in FIG. 11, when the user moves the selection designation bar displayed in the search result display region (fourth display region) by the mouse or the like and selects a desired histogram, only the corresponding histogram on the screen is displayed, highlighted, or blinked, for example, in a color different from the other histograms. In the example illustrated in FIG. 11, a state in which the histogram positioned at the foremost is selected is illustrated. In the present embodiment, the selection designation bar is indicated using a shape with a width as an example in order to facilitate understanding of description, but the selection designation bar need not be necessarily a shape with a width and may be configured to move a cursor to a desired histogram and select it by clicking.

When the selection input to the histogram positioned at the forefront by the user is detected as illustrated in FIG. 11, the calculating unit 35 transmits information specifying the selected histogram to the analysis assistance device 2 via the communication I/F 32 and the network 4.

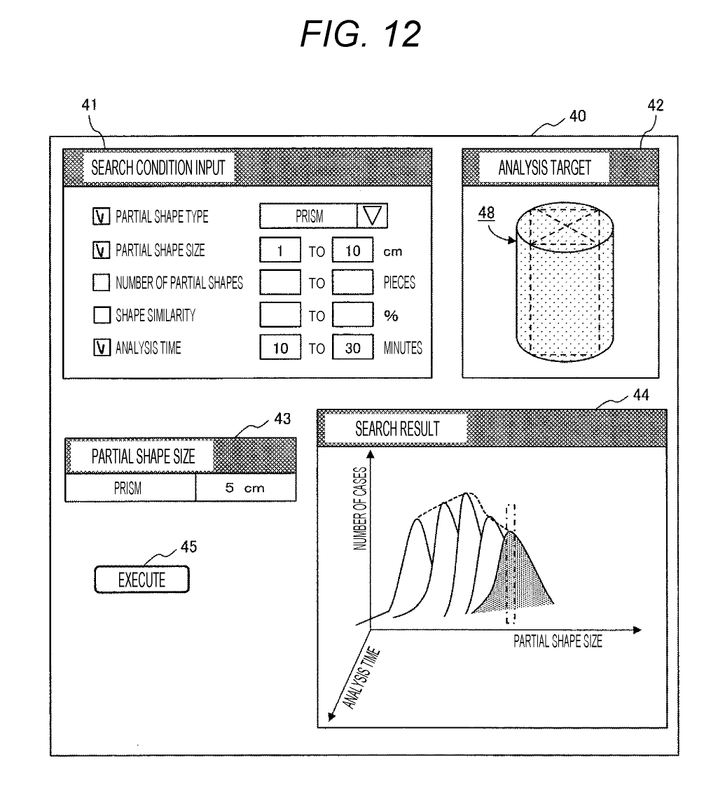

In step S18, the distribution output/selection receiving unit 28 constituting the analysis assistance device 2 acquires the information specifying the selected histogram via the communication I/F 22 and the internal bus 29 and obtains the partial shape size on the basis of the selected histogram. The distribution output/selection receiving unit 28 transmits the obtained partial shape size “5 cm” to the electronic terminal device 3a via the communication I/F 22 and the network 4. Upon receiving the partial shape size from the analysis assistance device 2, the electronic terminal device 3a causes “5 cm” to be displayed in the partial shape display region (third display region) 43 in the display screen 40 of the display unit 34 as the partial shape size of the “prism” which is the partial shape as illustrated in FIG. 12.

In the present embodiment, “cm” is used as a unit of the “partial shape size” which is a search item displayed in the search condition input region (first display region) 41 in the display screen 40 of the electronic terminal device 3a, and “minute” is used as a unit of the “analysis time” which is the search item, but the present invention is not limited thereto. For example, “mm” may be used as the unit of the “partial shape size,” and “hour” may be used as the unit of the “analysis time.”

Further, the units may be mixed, and in this case, when the case search unit 26 searches the case database 21, it is preferable to unify (convert) the unit of the “partial shape size” and the “analysis time” which are the search item.

In a process of step S18 and subsequent steps illustrated in FIG. 7, for example, it is displayed on a screen in which the analysis model obtained by dividing the analysis target in accordance with the obtained partial shape size, that is, the mesh model is generated on the display screen 40 of the electronic terminal device. Further, the analysis model displayed on the screen may be configured such that the user can revise the size of the desired partial shape for each partial shape later.

In the present embodiment, in the process of up to step S18 illustrated in FIG. 7, the obtained partial shape size is displayed on the display screen 40 of the electronic terminal device using a numerical value, but the present invention is not limited thereto. For example, the process may stop in step S16 of FIG. 7. It is because, in this case, the user is able to know a setting of division into the partial shapes which has been most frequently performed on the analysis target in the past.

As described above, according to the present embodiment, it is possible to easily divide the analysis target into partial shapes on the basis of the previous analysis case without depending on the degree of skill of the user. Further, it is possible to reduce the efforts of the user in the extraction of the previous analysis case, and it is possible to extract an optimal previous analysis case.

### Second Embodiment

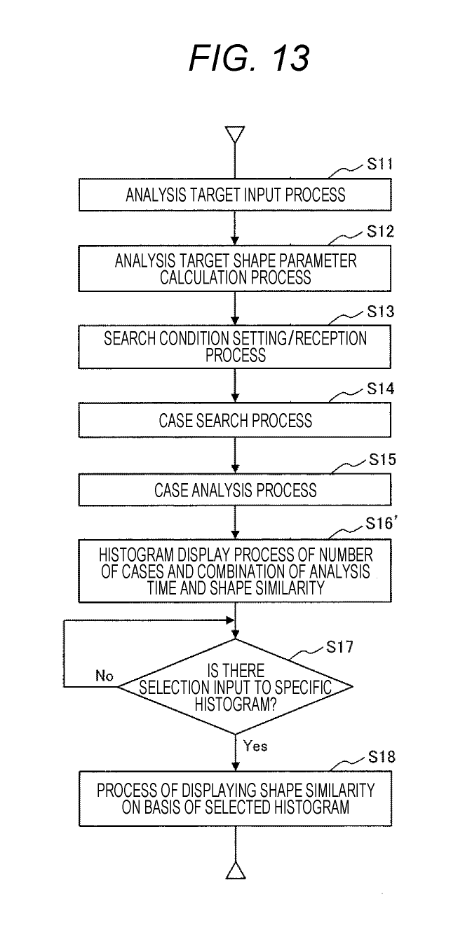

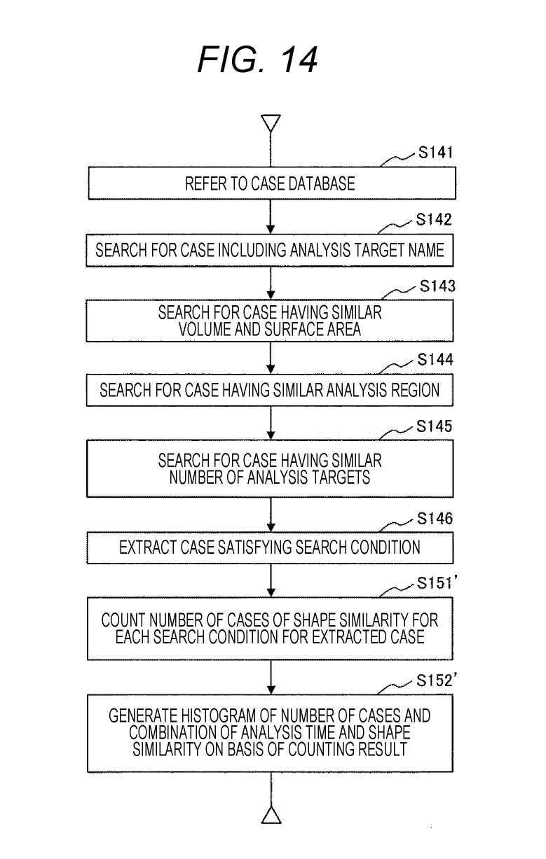

FIG. 13 is a flowchart illustrating a processing process performed in an analysis assistance system of a second embodiment according to another embodiment of the present invention, and FIG. 14 is a flowchart illustrating a processing process of the case search unit and the analyzing unit constituting the analysis assistance device. The same reference numerals denote the same constituent elements as those described in the first embodiment, and duplicate description will be omitted below. The present embodiment differs from the first embodiment in that a histogram of the number of previous analysis cases and the combination of the analysis time and the shape similarity is generated.

Even in the present embodiment, an overall configuration of the analysis assistance system 1 and overall configurations of the analysis assistance device 2 and the electronic terminal device (3a to 3d) constituting the analysis assistance system 1 are the same as those described above with reference to FIGS. 1 to 3. Further, a process between the analysis assistance device 2 and the electronic terminal device 3a will be described below in connection with an example in which the “analysis target name” is a “shaft (rotating shaft) of an electric motor, ” and the “analysis target” is a “columnar object.”

The analysis target input process (step S11) and the analysis target shape parameter calculation process (step S12) illustrated in FIG. 13 are similar to those of the first embodiment.

In a search condition setting/reception process (step S13), firstly, the search condition designated by the user and input to the search condition input region (first display region) 41 in the display screen 40 of the display unit 34 of the electronic terminal device 3a is received. In the present embodiment, an example in which a “prism” is designated and input as the “partial shape type,” “60% to 100%” is designated and input as the “shape similarity,” and “10 minutes to 30 minutes” is designated and input as the “analysis time” as the search condition will be described.

Step S14 (the case search process) executed by the case search unit 26 and step S15 (the case analysis process) executed by the analyzing unit 27 are illustrated in FIG. 14 in detail. Steps S141 to S145 illustrated in FIG. 14 are similar to those in the first embodiment.

In step S146, the case search unit 26 searches for a previous analysis case satisfying the search condition in which the “partial shape type” is “prism,” the “shape similarity” is “60% to 100%,” and the “analysis time” is “10 minutes to 30 minutes” among the previous analysis cases extracted in step S145 and extracts the corresponding previous analysis case. The previous analysis case satisfying the extracted search condition is transmitted from the case search unit 26 to the analyzing unit 27 via the internal bus 29.

In step S151′, the analyzing unit 27 counts the number of cases of the shape similarity for each search condition for the previous analysis case satisfying the search condition extracted by the case search unit 26. At this time, the number of cases of the analysis time is also counted together.

In step S152′ , the analyzing unit 27 generates a histogram indicating a relation between the number of cases and a combination of the analysis time and the shape similarity on the basis of the counting result of the number of cases obtained in step S151′.

Further, step S145 of FIG. 14 is skipped if the analysis region transmitted from the electronic terminal device 3a to the analysis assistance device 2 is the entirety of one analysis target 48 or one or more arbitrary partial regions of the analysis target 48. In other words, step S146 is executed after step S144 is executed. In the present embodiment, the example in which the case search unit 26 executes steps S143 to S145 serially is described, but the present invention is not limited to this. For example, the case search unit 26 may be configured to execute step S143, step S144, and step S145 in parallel. However, in this case, it is preferable to take AND (logical product) of the previous analysis cases obtained by executing step S143 to step S145 in parallel and then proceed to step S146.

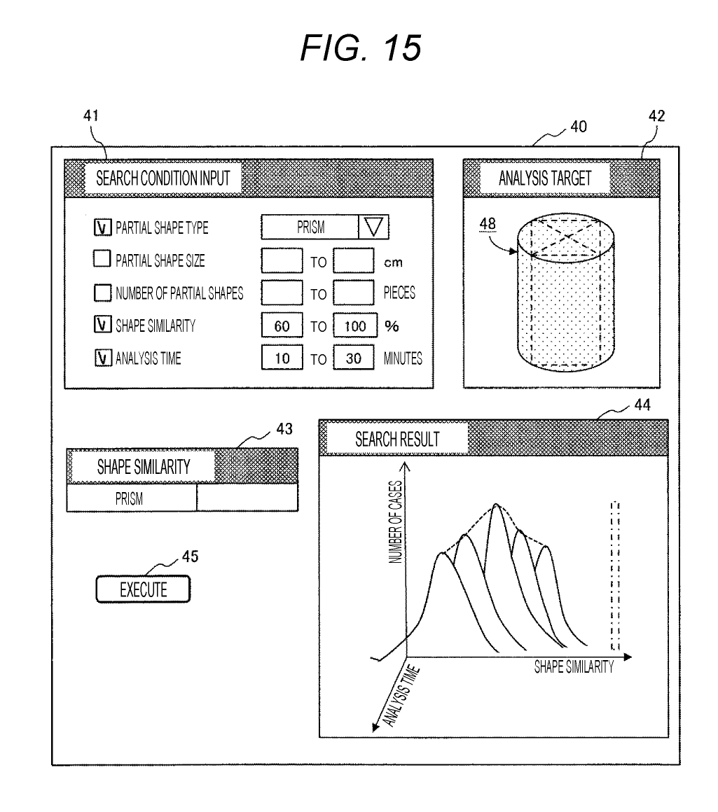

Here, the histogram display process (step S16′) of the number of cases and the combination of the analysis time and the shape similarity will be described with reference to FIG. 13. In step S16′, the distribution output/selection receiving unit 28 receives the execution result of step S15, that is, the histogram indicating the relation between the number of cases and the combination of the analysis time and the shape similarity obtained in step S152′ illustrated in FIG. 14 from the analyzing unit 27 via the internal bus 29. The distribution output/selection receiving unit 28 outputs the histogram indicating the relation between the number of cases and the combination of the analysis time and the shape similarity to the electronic terminal device 3a via the communication I/F 22 and the network 4. The electronic terminal device 3a causes the received histogram indicating the relation between the number of cases and the combination of the analysis time and the shape similarity to be displayed on the display unit 34 via the communication I/F 32. FIG. 15 illustrates a display screen example of the display unit 34 of the electronic terminal device 3a at this time. As illustrated in FIG. 15, a plurality of histograms in which an X axis indicates the shape similarity, a Y axis indicates the analysis time, and a Z axis indicates the number of cases are displayed on the search result display region (fourth display region) 44 in the display screen 40. A dotted line connecting apexes of the displayed histograms indicates a shape similarity in which the number of cases is the largest in each histogram, and the analysis time decreases as the position of the histogram gets closer to the front. In other words, the analysis speed increases as the position of the histogram gets closer to the front. As described above, as the shape similarity increases, the partial shape size decreases, and thus the analysis time increases (the analysis speed decreases). Therefore, the shape similarity and the analysis time are in a proportional relation.

Further, as illustrated in FIG. 15, the search condition in which the “partial shape type” is the “prism,” the “shape similarity” is “60% to 100%,” and the “analysis time” is “10 minutes to 30 minutes” is designated and input in the search condition input region (first display region) 41 in the display screen 40 of the display unit 33 of the electronic terminal device 3a. Usually, it is difficult to set the analysis accuracy for the shape in which the analysis target is complicated. Therefore, the present embodiment is focused on this point, and the user is able to set the shape similarity which is the similarity between the analysis target and the analysis model at the time of shape modeling instead of the analysis accuracy, and thus it is possible to design the analysis model based on the previous analysis case in a state approximated to the analysis accuracy.

As described above, since the respective histograms are displayed, in a case in which the user is an unskilled person or in the case of a shape on which analysis is performed for the first time even if the user is a skilled person, it is possible to understand the relation between the number of previous analysis cases and the combination of the analysis time and the shape similarity in one glance, and it is possible to reduce the efforts of the user at the time of analysis modeling.

In the state illustrated in FIG. 15, in addition to the histogram, a rectangular selection designation bar (indicated by an alternate long and short dash line in FIG. 15) that enables the user to perform selection and designation is displayed on the search result display region (fourth display region) 44.

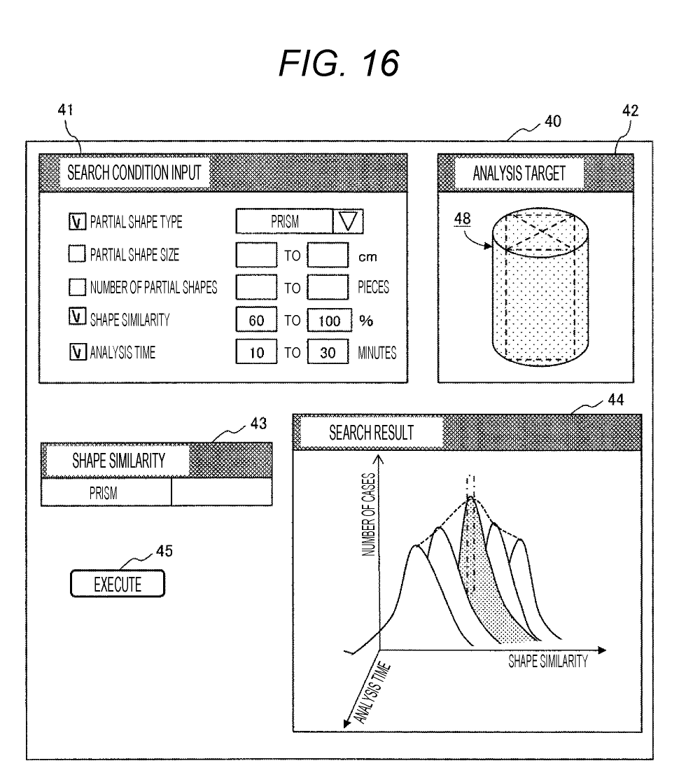

Then, in step S17 illustrated in FIG. 13, the calculating unit 35 constituting the electronic terminal device 3a determines the presence or absence of a selection input to a specific histogram by the user for the histogram indicating the relation between the number of cases and the combination of the analysis time and the shape similarity displayed in the search result display region (fourth display region) in the display screen. The determination on the presence or absence of the selection input is repeatedly executed until there is a selection input to the specific histogram by the user. As illustrated in FIG. 16, when the user moves the selection designation bar displayed in the search result display region (fourth display region) by the mouse or the like and selects a desired histogram, only the corresponding histogram on the screen is displayed, highlighted, or blinked, for example, in a color different from the other histograms. In the example illustrated in FIG. 16, a state in which a third histogram from the front is selected is illustrated. In the present embodiment, the selection designation bar is indicated using a shape with a width as an example in order to facilitate understanding of description, but the selection designation bar need not be necessarily a shape with a width and may be configured to move a cursor to a desired histogram and select it by clicking.

When the selection input to the third histogram from the front by the user is detected as illustrated in FIG. 16, the calculating unit 35 transmits information specifying the selected histogram to the analysis assistance device 2 via the communication I/F 32 and the network 4.

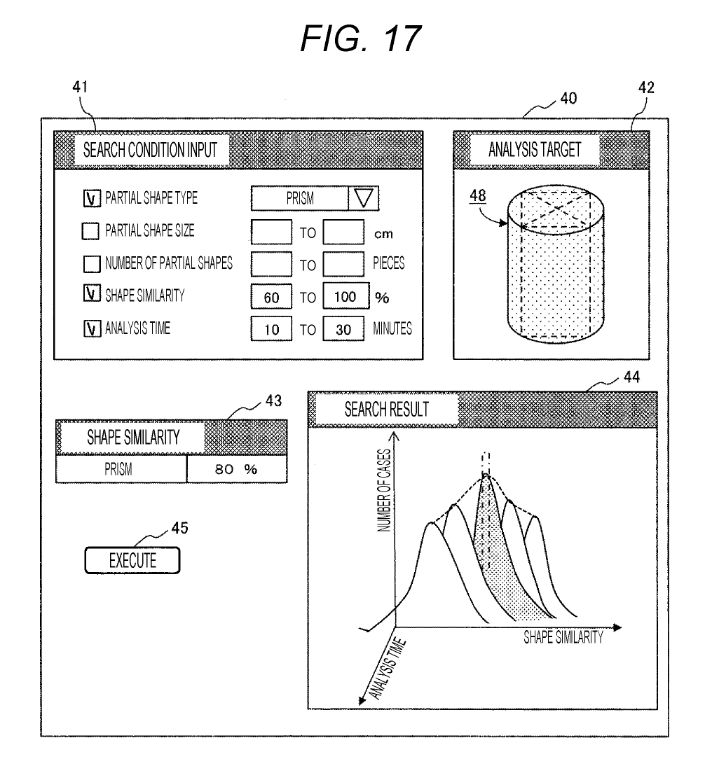

In step S18, the distribution output/selection receiving unit 28 constituting the analysis assistance device 2 acquires the information specifying the selected histogram via the communication I/F 22 and the internal bus 29 and obtains the shape similarity on the basis of the selected histogram. The distribution output/selection receiving unit 28 transmits the obtained shape similarity “80%” to the electronic terminal device 3a via the communication I/F 22 and the network 4. Upon receiving the shape similarity from the analysis assistance device 2, the electronic terminal device 3a causes “80%” to be displayed in the partial shape display region (third display region) 43 in the display screen 40 of the display unit 34 as the shape similarity of the “prism” which is the partial shape as illustrated in FIG. 17.

In a process of step S18 and subsequent steps illustrated in FIG. 13, for example, it is displayed on a screen in which the analysis mode obtained by dividing the analysis target in accordance with the partial shape size of the previous analysis case corresponding to the obtained shape similarity, that is, the mesh model is generated on the display screen 40 of the electronic terminal device. Further, the analysis model displayed on the screen may be configured such that the user can revise the size of the desired partial shape for each partial shape later.

In the present embodiment, in the process of up to step S18 illustrated in FIG. 13, the obtained shape similarity is displayed on the display screen 40 of the electronic terminal device using a numerical value, but the present invention is not limited thereto. For example, the process may stop in step S16 of FIG. 13. It is because, in this case, the user is able to know a setting of division into the partial shapes which has been most frequently performed on the analysis target in the past.

Originally, the analysis model is used for thermal variance analysis or stress analysis, or the like, and the required accuracy is high. The analysis accuracy and the analysis time are in a trade-off relation, and it is difficult to set the analysis accuracy as described above. According to the present embodiment, in addition to the effects of the first embodiment, since the shape similarity is introduced, the user is able to determine the trade-off between the shape similarity and the analysis time on the display screen 40 of the electronic terminal device and set them in analysis targets having different shapes. Further, since the setting of the shape similarity can be designated in a visualized state and performed on the basis of the previous cases, even unskilled persons can easily set it.

In the first embodiment described above, the histogram indicating the relation between the number of cases and the combination of the analysis time and the partial shape size is displayed on the display screen of the electronic terminal device, and in the second embodiment, the histogram of the number of cases and the combination of the analysis time and the shape similarity is displayed on the display screen of the electronic terminal device. However, the present invention is not limited thereto, and the histogram indicating the relation between the number of cases and the combination of the analysis time and the partial shape size and the histogram indicating the relation between the number of cases and the combination of the analysis time and the shape similarity may be displayed in a single display region or different display region in the display screen of the electronic terminal device.

Further, the present invention is not limited to the above-described embodiments and includes various modifications. For example, the above-described embodiments have been described in detail in order to facilitate understanding of the present invention and are not necessarily limited to a configuration having all the described components. Further, it is also possible to replace some components of an embodiment with components of another embodiment, and it is also possible to add a component of an embodiment to a component of another embodiment. Further, addition, deletion, or replacement of a component of another embodiment may be performed on a component of each embodiment.

### REFERENCE SIGNS LIST

1 analysis assistance system
2 analysis assistance device
3a, 3b, 3c, 3d electronic terminal device
4 network
5 router
6 switch
21 case database
22 communication I/F
23 analysis target input unit
24 analysis shape parameter calculating unit
25 search condition setting unit
26 case search unit
27 analyzing unit
28 distribution output/selection receiving unit
29 internal bus
31 external storage I/F
32 communication I/F
33 input unit
34 display unit
35 calculating unit
36 file access unit
37 storage unit
38 battery unit
39 internal bus
40 display screen
41 search condition input region (first display region)
42 analysis target display region (second display region)
43 partial shape display region (third display region)
44 search result display region (fourth display region)
45 execution button
47, 48 analysis target

1. An analysis assistance system, comprising:
an analysis assistance device connected to at least one or more electronic terminal devices via a network,
wherein the analysis assistance device comprises
a case database that accumulates a plurality of previous analysis cases, and
a case search unit that searches the case database,
the case search unit searches the case database, extracts a previous analysis case similar to an analysis target received from the electronic terminal device via the network, generates a histogram of a combination of an analysis time and a partial shape size and/or a combination of an analysis time and shape similarity at the time of analysis modeling in the extracted previous analysis case, and causes the histogram to be displayed on a display unit of the electronic terminal device.

2. The analysis assistance system according to claim 1,
wherein the case database stores at least a name of the analysis target, a shape parameter of the analysis target, the number of partial shapes constituting an analysis model, and an analysis time for each previous analysis case in association with one another,
the analysis assistance device further comprises an analysis target shape parameter calculating unit that calculates a shape parameter including a volume and/or a surface area of the analysis target received via the network, and
the case search unit searches the case database on the basis of the shape parameter obtained by the analysis target shape parameter calculating unit.

3. The analysis assistance system according to claim 2,
wherein the analysis model is configured with a plurality of partial shapes, and the partial shape is a three dimensional element including a trigonal pyramid which is a tetrahedral element or a triangular prism which is a pentahedral element.

4. The analysis assistance system according to claim 3,
wherein the shape similarity is similarity between the shape parameter including the volume and/or the surface area of the analysis target received via the network and a shape parameter including a volume and/or a surface area of an analysis model after the analysis target is divided into a plurality of partial shapes.

5. The analysis assistance system according to claim 4,
wherein the display unit of the electronic terminal device includes at least a first display region in which any one of a type of the partial shape, a size of the partial shape, shape similarity, and an analysis time is able to be designated as a search condition and a second display region in which the analysis target is displayed.

6. The analysis assistance system according to claim 5,
wherein the analysis assistance device further comprises an analyzing unit,
the case search unit extracts a previous analysis case satisfying a search condition from the case database when the type of the partial shape, the size of the partial shape, and the analysis time are designated as the search condition in the first display region, and
the analyzing unit counts the number of previous analysis cases corresponding to each of the designated analysis time and the partial shape size for the previous analysis case satisfying the search condition extracted by the case search unit, and generates a histogram of a combination of the analysis time and the partial shape size.

7. The analysis assistance system according to claim 5,
wherein the analysis assistance device further comprises an analyzing unit,
the case search unit extracts a previous analysis case satisfying a search condition from the case database when the type of the partial shape, the shape similarity, and the analysis time are designated as the search condition in the first display region, and
the analyzing unit counts the number of previous analysis cases corresponding to each of the designated analysis time and the shape similarity for the previous analysis case satisfying the search condition extracted by the case search unit, and generates a histogram of a combination of the analysis time and the shape similarity.

8. The analysis assistance system according to claim 6,
wherein the display unit of the electronic terminal device includes a third display region in which the histogram of the combination of the analysis time and the partial shape size generated by the analyzing unit is displayed, and
a desired histogram is able to be selected among a plurality of histograms displayed in the third display region.

9. The analysis assistance system according to claim 7,
wherein the display unit of the electronic terminal device includes a third display region in which the histogram of the combination of the analysis time and the shape similarity generated by the analyzing unit is displayed, and
a desired histogram is able to be selected among a plurality of histograms displayed in the third display region.

10. An analysis assistance method, comprising:
an analysis target input process of receiving, by an analysis assistance device, an analysis target from at least one or more electronic terminal devices via a network;
a case search process of searching a case database that accumulates a plurality of previous analysis cases for a previous analysis case similar to the received analysis target and extracting the previous analysis case;
a process of generating, by the analysis assistance device, a histogram of a combination of an analysis time and a partial shape size and/or a combination of an analysis time and shape similarity at the time of analysis modeling in the extracted previous analysis case; and
a process of causing the generated histogram of the combination of the analysis time and the partial shape size and/or the combination of the analysis time and the shape similarity at the time of analysis modeling to be displayed on a display unit of the electronic terminal device.

11. The analysis assistance method according to claim 10,
wherein the case database stores at least a name of the analysis target, a shape parameter of the analysis target, the number of partial shapes constituting an analysis model, and an analysis time for each previous analysis case in association with one another, and
the analysis assistance method further comprises a analysis target shape parameter calculation process of calculating a shape parameter including a volume and/or a surface area of the analysis target received via the network, and
the case search process comprises searching the case database on the basis of the calculated shape parameter.

12. The analysis assistance method according to claim 11,
wherein the analysis model is configured with a plurality of partial shapes, and the partial shape is a three dimensional element including a trigonal pyramid which is a tetrahedral element or a triangular prism which is a pentahedral element.

13. The analysis assistance method according to claim 12,
wherein the shape similarity is similarity between the shape parameter including the volume and/or the surface area of the analysis target received via the network and a shape parameter including a volume and/or a surface area of an analysis model after the analysis target is divided into a plurality of partial shapes.

14. The analysis assistance method according to claim 13, further comprising,
a process of causing at least a first display region in which anyone of a type of the partial shape, a size of the partial shape, shape similarity, and an analysis time is able to be designated as a search condition and a second display region in which the analysis target is displayed to be displayed on the display unit of the electronic terminal device.

15. The analysis assistance method according to claim 14,
wherein the case search process comprises extracting a previous analysis case satisfying a search condition from the case database when the type of the partial shape, the size of the partial shape, and the analysis time are designated as the search condition in the first display region, and
the process of generating, by the analysis assistance device, the histogram comprises counting the number of previous analysis cases corresponding to each of the designated analysis time and the partial shape size for the extracted previous analysis case satisfying the search condition and generating a histogram of a combination of the analysis time and the partial shape size.

16. The analysis assistance method according to claim 14,
wherein the case search process comprises extracting a previous analysis case satisfying a search condition from the case database when the type of the partial shape, the shape similarity, and the analysis time are designated as the search condition in the first display region, and
the process of generating, by the analysis assistance device, the histogram comprises counting the number of previous analysis cases corresponding to each of the designated analysis time and the shape similarity for the extracted previous analysis case satisfying the search condition and generating a histogram of a combination of the analysis time and the shape similarity.
